(19) United States
(12) Patent Application Publication
(10) Pub. No.: US 2017/0132820 A1
(43) Pub. Date: May 11, 2017

(54) METHOD AND SYSTEM FOR MITIGATING COLOR MUTATION IN IMAGE FUSION

(71) Applicant: Leauto Intelligent Technology (BEIJING) Co. Ltd, Beijing (CN)

(72) Inventor: Xun ZHOU, Beijing (CN)

(21) Appl. No.: 14/978,718

(22) Filed: Dec. 22, 2015

(30) Foreign Application Priority Data
Nov. 11, 2015 (CN) 201510766257.2

(51) Int. Cl. G06T 11/60; G06T 7/40; G06K 9/62

(52) U.S. Cl. CPC G06T 11/60; G06K 9/6215; G06T 7/408; G06T 2207/20221; G06T 2207/20021

(57) ABSTRACT

The embodiments of the present disclosure provide a method, a system, and a panoramic apparatus for mitigating color mutation in image fusion. The method is applicable to a panoramic apparatus including N imaging devices, the method includes the steps of: quantizing electrical signals of images acquired by respective imaging device to form each image to be fused of the panoramic image; calculating differences of fusion regions of the adjacent images to be fused; and performing gain adjustment on the images to be fused so that the differences of fusion regions of the adjacent images to be fused are in a preset range. With the technical solutions provided by the present disclosure, the output luminance and chroma of fusion regions of all adjacent images to be fused may be maintained substantially same, muting the problems in effectiveness, over consumption of resources and processing efficiency.

### CROSS-REFERENCE TO RELATED APPLICATIONS

This application is based on and claims priority to Chinese Patent Application No. 201510766257.2, with the title of “METHOD AND SYSTEM FOR MITIGATING COLOR MUTATION IN IMAGE FUSION”, filed on Nov. 11, 2015, the full disclosure of which is hereby incorporated by reference in its entirety.

### FIELD OF TECHNOLOGY

The present disclosure is related to image mosaic, and more particularly to a method and a system for mitigating color mutation in image fusion.

### BACKGROUND

Image mosaic technique is a technique for generating a panoramic image with a plurality of images with overlapped parts, where the plurality of images with overlapped parts may be images photographed in different angles of view.

The images photographed in different angles of view are obtained by a plurality of (two or more) imaging devices (such as camera) at the same time. A typical application of such kind of image mosaic construction is a multi-camera mosaic type of panoramic camera, panoramic parking system, and so on. As key technology for image mosaic, image fusion is a technique for overlapping the fields of view aligning regions of the images to be fused, i.e., fusion regions, to obtain a gap-free panoramic image reconstructed by splicing. However, it can be understood from the foregoing instruction of image mosaic technology that, the plurality of imaging devices photograph images at the same time using dependent exposures respectively, and the lighting conditions for photographing in different angles of view may be different, and then the adjustment for exposures made by the imaging devices according to the scenarios may inevitably cause the differences in luminance and chroma of the acquired images to be fused. If the images to be fused with differences in luminance and chroma are overlapped for image fusion, the differences may be increased by contrasting, which may lead to the color mutation in the fused panoramic image at last so that the visual effect may be degraded. It is apparent to one skilled in the art that larger the differences in luminance and chroma among images are, more obvious the color mutation in the fused panoramic image may be.

With respect to such problem in the image fusion technology, it is mainly used in the related art that the luminance and the chroma are adjusted using image processing algorithms. Although the image processing algorithms may be different, and the processing timing may be different, for example, a smoothing processing may be performed on the panoramic image before or after image fusion, there are following disadvantages: 1. It is difficult to radically solve the problem of differences in luminance and chroma among the images to be fused and there is the effect inherent in the effectiveness of the image processing algorithm; 2. the image processing algorithms are generally complicated, which may cause great consumption of the system application resources, and the consumption may be sharply increased as the increasing of the image resolution; and 3. the consumption of the system application resources may further cause the degrading of the processing efficiency.

Therefore, it is a technical difficulty how to make the transition of images in the fusion regions more natural in a simple and effective way, and thus it is necessary to provide a new technique to mitigating color mutation in image fusion.

### SUMMARY

To solve such problem, the present disclosure provides a method for mitigating color mutation in image fusion, which is applicable to a panoramic apparatus including N imaging devices, the method includes the steps of: quantizing electrical signals of images acquired by respective imaging device to form each image to be fused of the panoramic image; calculating differences of fusion regions of the adjacent images to be fused; and performing a gain adjustment on the images to be fused so that the differences of fusion regions of the adjacent images to be fused are in a preset range, wherein N is greater than or equal to 2.

The present disclosure also provides a system for mitigating color mutation in image fusion, which is applicable to a panoramic apparatus including N imaging devices, the system includes: a quantizing unit configured to respective quantize electrical signals of images acquired by each imaging device to form each image to be fused of the panoramic image; a data processing unit configured to calculate differences of fusion regions of the adjacent images to be fused; and a gain adjusting unit configured to perform a gain adjustment on the images to be fused so that the differences of fusion regions of the adjacent images to be fused are in a preset range, wherein N is greater than or equal to 2.

The present disclosure also provides a panoramic apparatus, including: N imaging devices, wherein N is greater than or equal to 2; N A-D convertors connected with the N imaging devices respectively and configured to quantize electrical signals of images acquired by respective imaging device to form each image to be fused of the panoramic image; N processors, connected with the N A-D convertors and configured to calculate differences of fusion regions of the adjacent images to be fused, and perform a gain adjustment on the images to be fused so that the differences of fusion regions of the adjacent images to be fused are in a preset range.

The present disclosure also provides a system for mitigating color mutation in image fusion, which is applicable to a panoramic apparatus including N imaging devices, the system includes: one or more processors; a memory; and one or more programs stored in the memory and configured to perform operations when executed by the one or more processors, wherein the operations include: quantizing electrical signals of images acquired by each imaging device to form respective image to be fused of the panoramic image; calculating differences of fusion regions of the adjacent images to be fused; and performing a gain adjustment on the images to be fused so that the differences of fusion regions of the adjacent images to be fused are in a preset range, wherein N is greater than or equal to 2.

With the technical solution of the present disclosure, it is possible to perform a gain adjustment in a hardware manner, so that the output luminance and chroma of the fusion regions of the adjacent images to be fused may be kept same with each other, muting the problems in effectiveness, over consumption of resources and processing efficiency due to the fact that the luminance and chroma are adjusted by using image processing algorithms in the prior image fusion technology.

A series of concepts in simplified form are introduced into the part of “SUMMARY”, and may be further clarified in detail in the part of “DESCRIPTION OF THE EMBODIMENTS”. The present part of “SUMMARY” may not be intended to limit the key characters and essential technical features of the claimed technical solution, nor be intended to determine the scope of the claimed technical solution.

The advantages and characters of the present disclosure may be explained in detail in the following in connection with drawings.

### BRIEF DESCRIPTION OF THE DRAWINGS

FIG. 1 is a flowchart of an embodiment of a method for mitigating color mutation in image fusion provided by the present disclosure;

FIG. 2 is a flowchart of another embodiment of a method provided by the present disclosure;

FIG. 3 is a schematic diagram of a system for mitigating color mutation in image fusion provided by the present disclosure;

FIG. 4 is a block diagram of a panoramic apparatus provided by the present disclosure; and

FIG. 5 is a structural diagram of a system for mitigating color mutation in image fusion provided by the first embodiment of the present disclosure.

### DESCRIPTION OF THE EMBODIMENTS

In the following, description in detail would be made so as to provide a more complete understanding of the present disclosure. However, it is apparent to one skilled in the art that, the present disclosure may be implemented without one or more of these details. In other examples, some technical feature well-known in the related art may be omitted to avoid confusion with the present disclosure.

For complete understanding of the present disclosure, detailed structure may be offered in the following description. It is apparent to one skilled in the art that, the implementation of the present disclosure may not be limited to special details well-known to the skilled in the art. Preferable embodiments of the present disclosure may be described in detail in the following. However, the present disclosure may have other implementation except these detailed description.

As a subject, the present disclosure discloses a method for mitigating color mutation in image fusion, suitable for technical processing in the stage of image fusion during the image mosaic, so as to overcome various kinds of defects with respect to the adopting of image processing algorithms in prior image fusion technique.

Before detailed description on the method for mitigating color mutation in image fusion provided by the present disclosure in connection with embodiments, it may be necessary to claim the following with respect to the technical solutions of the present disclosure:

The application scenario of the present disclosure a is a panoramic imaging system, such as panoramic parking system, including N (2 or more) imaging devices. A plurality of imaging devices, such as camera, acquire electrical signals of images at the same time, so as to obtain a complete panoramic image reconstructed by splicing.

The above statements may be applicable to all embodiments of the present disclosure. In the following, detailed description would be made to the embodiments of the present disclosure.

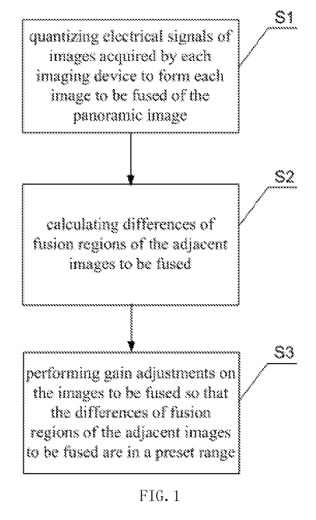

FIG. 1 is a flowchart of an embodiment of a method for mitigating color mutation in image fusion provided by the present disclosure. The method includes the following steps.

S1, quantizing electrical signals of images acquired by each imaging device to form each image to be fused of the panoramic image.

First, the present step is to process the electrical signals of images acquired by each imaging device, and the electrical signals of images may particularly acquired by a sensing element of the imaging device (such as image sensor).

Second, the present step is to quantize the electrical signals of the images to obtain the images to be fused. One skilled in the art should understand that, the term “images to be fused” cited herein refers to digital images which need image fusion processing so as to be spliced into a digital image of the panoramic image.

The quantizing processing may be implemented by an A-D convertor, and thus each images to be fused may be acquired. One skilled in the art may select a quantizing length of 8 bit, 16 bit, 24 bit or higher to quantize the electrical signals of the images according to the actual requirements of precision.

Furthermore, each images to be fused may be subject to a series of processing such as noise-removing and aligning before the processing of image fusion during image mosaic. That is to say, the technical solution provided by the present disclosure would not affect the applying of the prior technology in other procedures of the image mosaic. On the other hand, the prior technology in other procedures of the image mosaic may be used in combination with the technical solution provided by the present disclosure.

It should be noted that, step S1 should be performed on each frame of the panoramic image, otherwise it may be impossible to implement the reconstruction of the panoramic image.

S2, calculating differences of fusion regions of the adjacent images to be fused.

In the present step, the differences may refer to the statistic value of the differences of quantized values of corresponding positions of the fusion regions(aligned regions). For example, the differences may be the differences of the averages of all point pixels of adjacent images to be fused in the region, or may be the differences of pixel values of the sampled points calculated after sampling pixels of adjacent images to be fused in the region according to certain rules. Furthermore, one skilled in the art may use any other statistic value according practical needs.

S3, performing gain adjustments on the images to be fused so that the differences of fusion regions of the adjacent images to be fused are in a preset range.

The processing of making the differences of fusion regions of the adjacent images to be fused in a preset range by gain adjusting is a processing on the differences of luminance and chroma in a hardware way (gain amplifier or hardware processor capable of performing gain adjustment) so as to overcome the disadvantages caused by the image processing algorithms in related art. When the differences of fusion regions of adjacent images to be fused are extremely small, the differences in luminance and chroma of the overlapped regions of adjacent images to be fused are extremely small, so that the object of the present disclosure to overcome the color mutation of the panoramic image after splicing may be achieved.

It is apparent to one skilled in the art that, when the differences of fusion regions of adjacent images to be fused are zero, the optimum technical effect may be achieved. However, one skilled in the art may understand that, in the field of image processing, it is unrealistic for all the pixel values in the fusion regions to be exactly same, and therefore, the differences may be close to zero at most, and there is certainly an error range for such differences. For example, in the case that the grayscale value of a pixel is 255, the tolerant error for one pixel may be 5 or less or 10 or less. If the differences are within such preset tolerant error range, the fusion effect may not be affected visually since the differences are so small. The tolerant error range may be set according to practical demands on precision by skills in the art so as not to affect the implementation of the technical solution of the present disclosure.

It should also be noted that, step S1 should be performed on each frame of the panoramic image.

Therefore, through the implementation of steps S1-S3 as mentioned above, the object of the present disclosure may be achieved.

Furthermore, during the image mosaic, steps S1 and S3 may be performed frame by frame as described above, but S2 may be performed in different frequency as demanded.

For example, it may be feasible to perform the calculation of differences on each frame, i.e., perform steps S1-S3 on each frame of the panoramic image. Such manner of adjustment may achieve the optimum fusion effect with respect to the playing of dynamic panoramic images. However, the relative system cost may be large with respect to a camera system for contently displaying, such as a stereoscopic event data recording system, monitoring system, and so on.

As another embodiment, differences may be performed not in a frame-by-frame way considering the cases that the illumination may not be changed drastically, which include two cases.

As one case, the above step S2 may be performed again when the changes of imaging parameters reach a preset threshold. More particularly, in some circumstances such as outdoors in daytime, indoors where lights may not be turned on and off frequently, the luminance of each imaging device may not change drastically frequently. Therefore, after previous adjustment, if the adjacent image A is darker than the image B by 4 luminance values based on analysis of differences and the processor may control the luminance of all pixels of A to be increased by 4, step S3 may be performed while such gain is maintained without repeatedly performing S2 to recalculate the differences, until the changes of imaging parameters reach the preset threshold, for example, when a blocking occurs or there is a new light source causing a larger changes in luminance, or scenes for photographing are changed, so that a balance between effects and system cost may be achieved.

As another case, the differences may be calculated with a time interval of T, i.e., the step S2 may be performed once every time interval of T, and the previous gain adjustment may be maintained during other periods, so as to perform step S3 frame by frame. In such manner, the differences calculation may be performed periodically in the case that the changes of imaging parameters do not reach a preset threshold, so that adjustments may be performed constantly in stages and also a balance between effects and system cost may be achieved.

One skilled in the art may appreciate that the processing for the above cases may be used exclusively, i.e., to perform step S2 periodically or perform step S2 based on a threshold. The processing for the above two cases may be used in combination, so as to achieve preferable technical effects. Furthermore, choices for different processing as described above may be used in combination. For example, step S2 may be performed frame by frame in the case that parameters changes frequently, while in the case that parameters changes not so frequently, step S2 may be performed based on time interval of T and/or threshold.

Furthermore, there may be different implementations for the step S3 performed frame by frame in the above embodiment. As one implementation, for example, it is possible to take the middle value of differences of fusion regions of adjacent images to be fused and perform adjustment on these two adjacent images to be fused with this middle value, so that the differences therebetween may be close to zero.

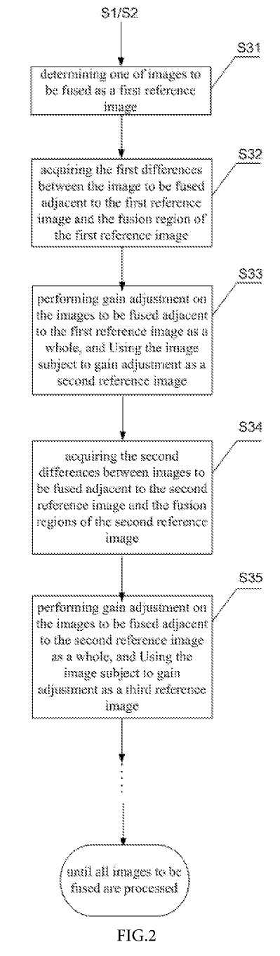

As a preferable embodiment, the present disclosure may provide a method for mitigating color mutation in image fusion as shown in FIG. 2. The steps S1 and S2 in FIG. 2 are same as those in the embodiments as shown in FIG. 1, except the step S2, which may be particularly implemented as follows.

S31, determining one of images to be fused as a first reference image. The first reference image may be determined according a preset rule.

More particularly, the first reference image may be determined according to the previous specifying of hardware. For example, the image to be fused acquired by one imaging device and subject to quantizing may be specified as the first reference image for fusion of each frame of the panoramic image. More particularly, the specifying for imaging devices may depend on practical cases, for example, may depend on which imaging device takes an electrical signal of image corresponding to the image to be fused more close to the core position for imaging, or which imaging device has the larger light-collecting area.

As one example, it may be possible to determine the first reference image according to the presetting of image parameters. For example, it may be possible to make analysis on quantized value of each image to be fused, determine the image to be fused whose analysis result is closest to the object parameter of the scene mode currently selected by the device as the first reference image. As another example, the image to be fused with the smallest difference with other images to be fused may be determined as the first reference image. There are other manners for determining the first reference image besides the manners described above.

Apparently, the present technical solution may select the first reference image randomly.

S32, acquiring the first differences between the image to be fused adjacent to the first reference image and the fusion region of the first reference image.

It should be noted that, the first differences acquired in the present step may be acquired by calculation on the current panoramic image, and may be the result of calculation of differences of fusion regions of adjacent images to be fused performed last time.

Furthermore, the images to be fused adjacent to the first reference image such as P0 may be more than one image, and then the differences D1, . . . , Dm between each adjacent images to be fused P1, . . . , Pm and the fusion regions of the first reference image P0 may be calculated respectively and the subsequent steps may be performed with respect to each differences D1, . . . , Dm.

S33, performing gain adjustment on the images to be fused adjacent to the first reference image as a whole, and the image subject to gain adjustment may be used as a second reference image.

In other words, P1 may be subject to gain adjustment with D1, Pm may be subject to gain adjustment with Dm and so on, the P1, . . . , Pm being adjusted may be used as the second reference images.

More particularly, the objects for gain adjustment are the quantized values of all pixel points of each image to be fused (P1, . . . , Pm), for example, the quantized value of all pixel points of P1 may be increased by x or decreased by y.

S34, acquiring the second differences between images to be fused adjacent to the second reference image and the fusion regions of the second reference image.

Likewise, the second differences acquired in the present step may be acquired by calculation on the current panoramic image, and may be the result of calculation of differences of fusion regions of adjacent images to be fused performed last time.

Furthermore, the images to be fused adjacent to the second reference image P1 may be more than one image such as P11, . . . , P1n, the images to be fused adjacent to the second reference image Pm may be more than one image such as Pm1, . . . , Pmk and then the differences D11, . . . , D1n, D1m1, . . . , Dmk between each adjacent images to be fused and the fusion regions of the first reference image may be calculated respectively and the subsequent steps may be performed with respect to each differences D11, . . . , D1n, D1m1, . . . , Dmk.

S35, performing gain adjustment on the images to be fused adjacent to the second reference image as a whole, and the image subject to gain adjustment may be used as a third reference image.

In other words, P11 may be subject to gain adjustment with D11, P1n may be subject to gain adjustment with D1n, Pm1 may be subject to gain adjustment with Dm1, Pmk may be subject to gain adjustment with Dmk and so on, the P11, . . . , P1n, Pm1, . . . , Pmk being adjusted may be used as the third reference images.

The above procedures may be applied to all other images to be fused in a similar way, until all images to be fused are processed.

As a preferable embodiment, a step of performing gain compensation to the first reference image may be performed after step S31 and before step S32. Such gain may be determined according to the object parameters of the currently selected scene mode, so that all images to be fused may have better quantized value parameter after being processed.

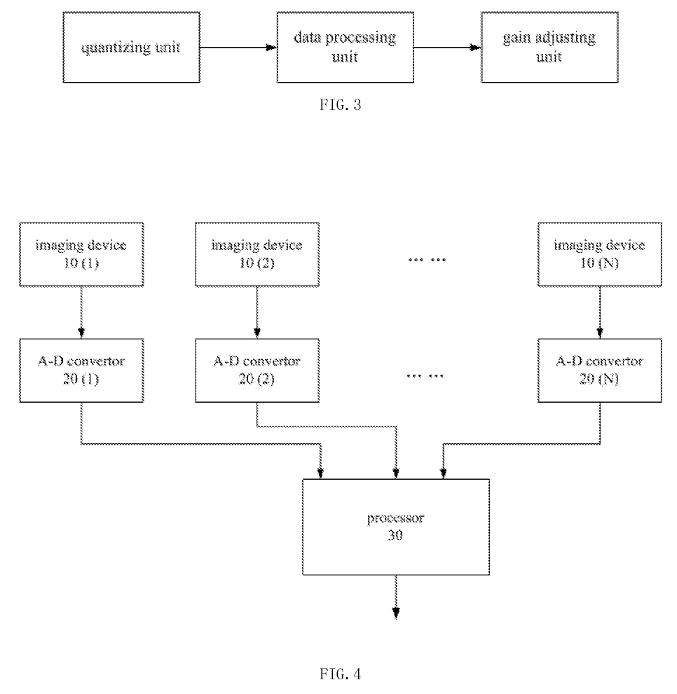

The methods for mitigating color mutation in image fusion provided by the present disclosure have been described in connection with embodiments in the above. Correspondingly, the present disclosure may provide a system for mitigating color mutation in image fusion, applicable to a panoramic apparatus including N imaging devices, wherein N is greater or equal to 2. As shown in FIG. 3, the system includes: a quantizing unit configured to quantize electrical signals of images acquired by each imaging device to form each image to be fused of the panoramic image, which may be implemented with an A-D convertor; a data processing unit configured to calculate differences of fusion regions of the adjacent images to be fused; and a gain adjusting unit configured to perform gain adjustment on the images to be fused so that the differences of fusion regions of the adjacent images to be fused are in a preset range, wherein N is greater than or equal to 2.

One skilled in the art may understand that, in the system for mitigating color mutation in image fusion, implementations and possible embodiments of each unit may refer to the description on corresponding method, and may have same technical effects, and thus may be omitted herein.

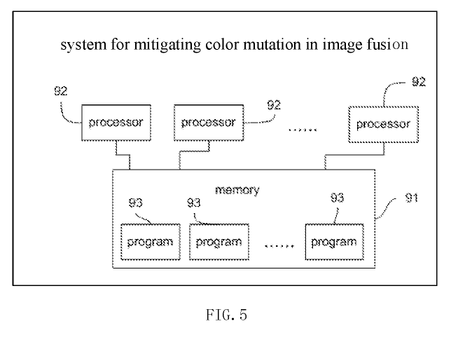

Furthermore, the present disclosure also provides a panoramic apparatus. As shown in FIG. 4, the panoramic apparatus may include N imaging devices 10 (1), 10 (2), . . . , 10 (N), wherein N is greater than or equal to 2. In other words, the panoramic apparatus is a panoramic apparatus including a plurality of imaging devices. And the imaging device may particular be an image sensor configured to acquire images.

The panoramic apparatus may further include N A-D convertors 20 (1), 20 (2), . . . , 20 (N), connected with the N imaging devices 10 (1), 10 (2), . . . , 10 (N) respectively and configured to quantize electrical signals of images acquired by each imaging device 10 (1), 10 (2), . . . , 10 (N) to form each image to be fused of the panoramic image.

The panoramic apparatus may further include processors 30, connected with the A-D convertors 20 (1), 20 (2), . . . , 20 (N), and configured to calculate differences of fusion regions of the adjacent images to be fused, and perform gain adjustment on the images to be fused so that the differences of fusion regions of the adjacent images to be fused are in a preset range (close to zero).

One skilled in the art may understand that, in the panoramic apparatus, implementations and possible embodiments of first processor 30 may refer to the description on corresponding method, and may have same technical effects, and thus may be omitted herein.

It should be also noted that, the panoramic apparatus may further include a processor and display for panoramic fusion or have such processor and display attached therewith. The implementation may be different according to the type of panoramic apparatus or needs, and the related description may be omitted herein.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for mitigating color mutation in image fusion, which is applicable to a panoramic apparatus comprising N imaging devices, the method comprises:
quantizing electrical signals of images acquired by respective imaging device to form each image to be fused of the panoramic image;
calculating differences of fusion regions of the adjacent images to be fused; and
performing a gain adjustment on the images to be fused so that the differences of fusion regions of the adjacent images to be fused are in a preset range, wherein N is greater than or equal to 2.

2. The method for mitigating color mutation in image fusion according to claim 1, further comprising performing calculating of differences of fusion regions of the adjacent images to be fused with respect to each frame of the panoramic image.

3. The method for mitigating color mutation in image fusion according to claim 1, further comprising performing calculating of differences of fusion regions of the adjacent images to be fused with a time interval T.

4. The method for mitigating color mutation in image fusion according to claim 1, further comprising performing calculating of differences of fusion regions of the adjacent images to be fused when changes of imaging parameters reach a preset threshold.

5. The method for mitigating color mutation in image fusion according to claim 1, wherein the performing a gain adjustment on the images to be fused comprises:
determining one of images to be fused as a first reference image;
acquiring the first differences between the image to be fused adjacent to the first reference image and the fusion region of the first reference image;
performing a gain adjustment on the images to be fused adjacent to the first reference image as a whole, and using the image subject to gain adjustment as a second reference image;
acquiring the second differences between images to be fused adjacent to the second reference image and the fusion regions of the second reference image; and
performing a gain adjustment on the images to be fused adjacent to the second reference image as a whole, and using the image subject to a gain adjustment as a third reference image; and
applying the above steps to all other images to be fused, until all images to be fused are processed.

6. The method for mitigating color mutation in image fusion according to claim 2, wherein the performing gain adjustment on the images to be fused comprises:
determining one of images to be fused as a first reference image;
acquiring the first differences between the image to be fused adjacent to the first reference image and the fusion region of the first reference image;
performing a gain adjustment on the images to be fused adjacent to the first reference image as a whole, and using the image subject to gain adjustment as a second reference image;
acquiring the second differences between images to be fused adjacent to the second reference image and the fusion regions of the second reference image; and
performing a gain adjustment on the images to be fused adjacent to the second reference image as a whole, and using the image subject to a gain adjustment as a third reference image; and
applying the above steps to all other images to be fused, until all images to be fused are processed.

7. The method for mitigating color mutation in image fusion according to claim 3, wherein the performing a gain adjustment on the images to be fused comprises:
determining one of images to be fused as a first reference image;
acquiring the first differences between the image to be fused adjacent to the first reference image and the fusion region of the first reference image;
performing a gain adjustment on the images to be fused adjacent to the first reference image as a whole, and using the image subject to a gain adjustment as a second reference image;
acquiring the second differences between images to be fused adjacent to the second reference image and the fusion regions of the second reference image; and
performing a gain adjustment on the images to be fused adjacent to the second reference image as a whole, and using the image subject to a gain adjustment as a third reference image; and
applying the above steps to all other images to be fused, until all images to be fused are processed.

8. The method for mitigating color mutation in image fusion according to claim 4, wherein the performing a gain adjustment on the images to be fused comprises:
determining one of images to be fused as a first reference image;
acquiring the first differences between the image to be fused adjacent to the first reference image and the fusion region of the first reference image;
performing a gain adjustment on the images to be fused adjacent to the first reference image as a whole, and using the image subject to a gain adjustment as a second reference image;
acquiring the second differences between images to be fused adjacent to the second reference image and the fusion regions of the second reference image; and
performing a gain adjustment on the images to be fused adjacent to the second reference image as a whole, and using the image subject to a gain adjustment as a third reference image; and
applying the above steps to all other images to be fused, until all images to be fused are processed.

9. The method for mitigating color mutation in image fusion according to claim 5, wherein the first reference image is determined according to the specifying on hardware.

10. The method for mitigating color mutation in image fusion according to claim 1, wherein the first reference image is determined according to pre-setting of image parameters.

11. The method for mitigating color mutation in image fusion according to claim 1, wherein after the first reference image is determined, the method further comprises performing gain compensation on the first reference image.

12. A system for mitigating color mutation in image fusion, which is applicable to a panoramic apparatus comprising N imaging devices, the system comprises:
one or more processors;
a memory; and
one or more programs stored in the memory and configured to perform operations when executed by the one or more processors, wherein the operations comprise:
quantizing electrical signals of images acquired by respective imaging device to form each image to be fused of the panoramic image;
calculating differences of fusion regions of the adjacent images to be fused; and
performing a gain adjustment on the images to be fused so that the differences of fusion regions of the adjacent images to be fused are in a preset range, wherein N is greater than or equal to 2.

13. A panoramic apparatus, comprising:
N imaging devices, wherein N is greater than or equal to 2;
N A-D convertors connected with the N imaging devices respectively, and configured to quantize electrical signals of images acquired by respective imaging device to form each image to be fused of a panoramic image; and
N processors connected with the N A-D convertors and configured to calculate differences of fusion regions of adjacent images to be fused, and perform a gain adjustment on the images to be fused so that the differences of fusion regions of adjacent images to be fused are in a preset range.
